(19) United States
(12) Patent Application Publication
(10) Pub. No.: US 2005/0267932 A1
(43) Pub. Date: Dec. 1, 2005

(54) Verification system determining whether a predefined segment within a media program has been displayed

(76) Inventor: Joshua Paul, Porter Ranch, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/139,300

(22) Filed: May 27, 2005

Related U.S. Application Data
(60) Provisional application No. 60/575,454, filed on May 27, 2004.

(51) Int. Cl. G06F 15/16

(52) U.S. Cl. 709/202

(57) ABSTRACT

Verification system verifies whether a viewer's terminal displayed a segment within an media program. The system includes embedding markings within the media program that indicate an identifier associated with the media program, the starting and ending points of the segment, and a mechanism for determining whether the segment was displayed within a predetermined time range. An observation application on the terminal where the media program is displayed may be capable of sending information regarding the display of a segment to the host server, which then may verify that the segment has been displayed and forwards this verification to a third party, such as an advertiser, who has agreed to provide compensation each time the segment is displayed on the terminal.

### RELATED APPLICATION

This application claims priority to a provisional application having a Ser. No. 60/575,454, entitled SYSTEM CAPBALE OF VERIFYING SEGMENT HAS BEEN VIEWED IN A MULTIMEDIA FILE, filed May 27, 2004, which is hereby incorporated by reference.

### BACKGROUND OF THE INVENTION

1. Field of the Invention

This invention provides a system capable of determining whether a segment of a media program has been displayed on one or more terminals. In particular, this invention determines whether a segment of a media program has been displayed partially or fully at one or more terminals and provides this information to a central database where it charges a third party which has contracted to provide compensation each time such segment has been displayed.

2. General Background and State of the Art

The development of practical method of sending a large size media program, such as feature length motion pictures, over computer networks such as the Internet presents content providers with opportunities and challenges. One of the opportunities is that the content providers can provide digital content to viewers without the expense of manufacturing and distributing physical copies of the content, such as DVD discs, to either theaters or to individual viewers. On the other hand, one of challenges with providing content through computer networks is exacting payment from viewers who prefer, or have even come to expect, that content transmitted through the computer networks be free of charge. One answer to this challenge is to insert product advertisements into a media program either overtly through commercial messages or less obviously, for instance, through the placement of an advertised product in a dramatic scene for which an advertiser will pay for the placement of its product.

Advertisers are concerned with the number of impressions, i.e., the number of viewings by unique viewers, each advertising message makes. Additionally, there is a great interest among advertisers to develop innovative methods of presenting advertising messages, such as product placement, to viewers who are becoming increasingly resistant to conventional commercial messages. Moreover, new technologies such as the personal video program recorder (PVR) make it easier to fast forward through overt commercial messages. This has made advertisers increasingly concerned as to whether their messages are being seen at all. In traditional broadcasting, where the same program was presented to millions of viewers simultaneously, the number of impressions was determined by a survey of how many households in a given area were watching a given program, with the presumption that every viewer saw every commercial message. With the advent of new technologies, such as internet-distributed video or PVRs, in which a program might be watched by any viewer at any given time—and watched partially, watched repeatedly, or not watched at all—it is difficult to gauge the number of times an advertising message is actually displayed. This in turn creates the problem setting fees for the advertisement. As such, there is a need to determine the number of times an advertising message has been displayed and the number of terminals that have displayed it, even over an extended period of time, such as weeks, months, or years.

### INVENTION SUMMARY

This invention provides a verification system capable of determining whether a segment of a media program, such as a commercial message or product placement, has been displayed on a terminal and whether the segment was displayed in its entirety or at least partially. This allows a content provider to charge an advertiser or other subscriber for displaying the segment, and for advertisers to determine whether the segment was displayed in a meaningful way. A media program may be received via radio wave, satellite, or cable, or it may be accessed or downloaded through the Internet. An observation application, which is able to detect marks within the media program, is loaded onto the terminal and can cause the terminal to communicate with a server. In the media program are a number of segments that the content provider wishes to verify that they have been displayed on the viewer's terminal. Embedded in the media program is a program identifier mark, a verification mark at the beginning of each verified segment, and a second or subsequent verification mark at the end of each verified segment. The marks may be embedded in the vertical blanking interval of the media signal, similar to closed captioning, or the audio or video portion of the media program, or as a script within a multimedia container, like Microsoft's Windows Media or Apple's QuickTime. There may be any number of segments identified in this manner.

Upon receiving and subsequently “displaying” the media program, a request is made to the server by the observation application via the terminal where the media program is displayed, to which the server may assign each display of the media program a unique ID. The observation application may also be able to generate or obtain a unique ID and transmit the unique ID to the server. The unique ID may be used in subsequent communication to identify individual terminals in order to accumulate better data about the display of a particular segment. The media program's terminal may be a set-top box, media center, gaming console, personal computer, PVR, video receiver, or cellular phone. When the media program is enclosed within a multimedia container, the observation application may be embedded within the media container, and the terminal may be the multimedia container's host application.

When the media program is displayed on a terminal and the verification mark for a particular segment is detected by the observation application on the viewer's terminal, a detection message is sent to the server along with the unique ID. Once this message is received by the server, a timer may be started. When the second or subsequent verification mark of the particular segment is detected by the viewer's terminal, a second or subsequent detection message is sent to the server along with the unique ID. When the subsequent message is received by the server, the timer may stop. The server calculates the amount of time that elapsed between the two detection messages, and compares that with the length of the segment to be verified when displayed at normal speed. If the elapsed time is within tolerance of the normal length of the segment or range, the display of the segment is verified and this information is stored in a database.

A number of subscribers may have contracted to provide compensation each time a verified segment is displayed on a terminal. The server queries the database and then notifies the subscriber that a verified segment has been displayed and the subscriber provides the agreed upon compensation.

### BRIEF DESCRIPTION OF THE DRAWINGS

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a flow chart showing the method of the invention.

FIG. 2 is a flow chart showing further details of the flow chart shown in FIG. 1.

FIG. 3 is a flow chart showing further details of the flow chart shown in FIG. 1.

FIG. 4 is a flow chart showing further details of the flow chart shown in FIG. 1.

FIG. 5 is a flow chart showing further details of the flow chart shown in FIG. 1.

FIG. 6 is a flow chart showing further details of the flow chart shown in FIG. 1.

FIG. 7 is a flow chart showing further details of the flow chart shown in FIG. 1.

### DETAILED DESCRIPTION OF THE PREFERRED EMBODIMENTS

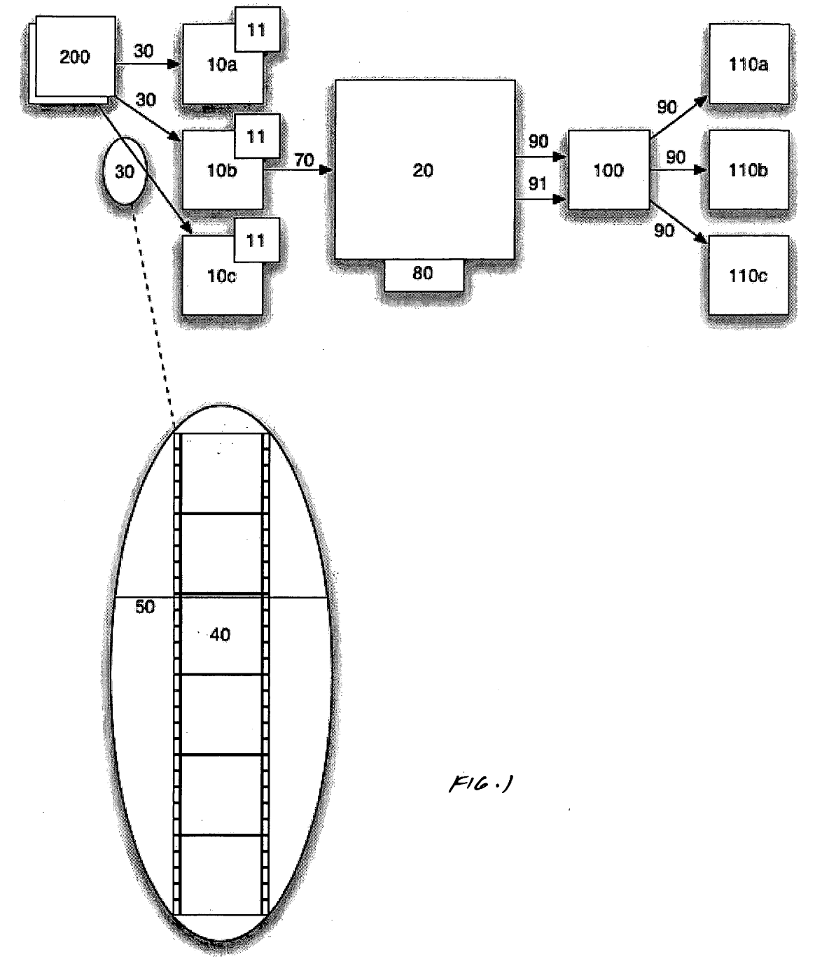

FIG. 1 shows a verification system capable of verifying that one or more terminals have displayed a number of predetermined segments within a media program and whether or not they are displayed in their entirety or a portion thereof. A plurality of viewer's terminals 10 may be connected via a network to a server 20. The plurality of terminals 10 may be capable of sending information to the server 20. An observation application 11 may be loaded on the plurality of terminals 10 that may be used to display a media program 30. The media program 30 may be available from one or more distributors 200. Within the media program 30 is at least one verifiable segment 40 marked by a segment marking 50. When the program 30 is played and the verifiable segment 40 has been displayed, the observation application 11 causes the terminal 10, where the verifiable segment 40 is being displayed, to send a detection message 70 to the server 20. The server 20 subjects the detection message 70 to a segment display verification 80, which verifies whether the verifiable segment 40 has been displayed in its entirety. If the server 20 verifies that the verifiable segment 40 has been displayed, the verification message 90 is sent to a database 100. Otherwise, a non-verification message 91 is sent to the database 100 by server 20, indicating that a partial observation has occurred, which then determines if at least one of a plurality of subscribers 110 has contracted to provide compensation if the segment 40 has been displayed in its entirety or a substantial portion of the segment 40. If so, the verification message 90 is sent to the subscriber 110 with the compensation arrangement, which provides the agreed upon compensation.

There may be a plurality of verifiable segments 40 in each media program 30 with a variety of compensation arrangements with the plurality of subscribers 110, where each subscriber has an agreement to provide compensation for a verified display or display of one or some or all of the verifiable segments 40. For example, the media program 30 may include nine verifiable segments 40. Five may be product placements of soft drinks, three may be product placements of toothpaste, and one may be a product placement of an automobile. There may be three subscribers that have agreed to provide compensation if certain verifiable segments 40 are displayed on one or more terminals. These subscribers may be a soft drink manufacturer 110a, a toothpaste manufacturer 110b, and an automobile manufacturer 110c. The media program 30 may be displayed using the terminal 10a and all nine verifiable segments 40 may be verifiably displayed. The media program 30 may be displayed using the terminal 10b, but only three of the product placements of soft drinks and one product placement of toothpaste may be displayed. The database 100 reports to the soft drink manufacturer 110a that two unique terminals have displayed eight verifiable segments 40; toothpaste manufacturer 110b that two unique terminals have displayed four verifiable segments 40; and automobile manufacturer 110c that one unique terminal displayed one verifiable segment 40.

In another example, the media program 30 may be displayed using the terminal 10a as in Example A, with the same nine verifiable segments. The program 30 may be displayed twice, and all verifiable segments 40 may be verifiably displayed twice each. The database 100 reports to the soft drink manufacturer 110a that one unique terminal has displayed ten verifiable segments 40, toothpaste manufacturer 110b that one unique terminal has displayed six verifiable segments 40, and automobile manufacturer 110c that one unique terminal has displayed two verifiable segments 40.

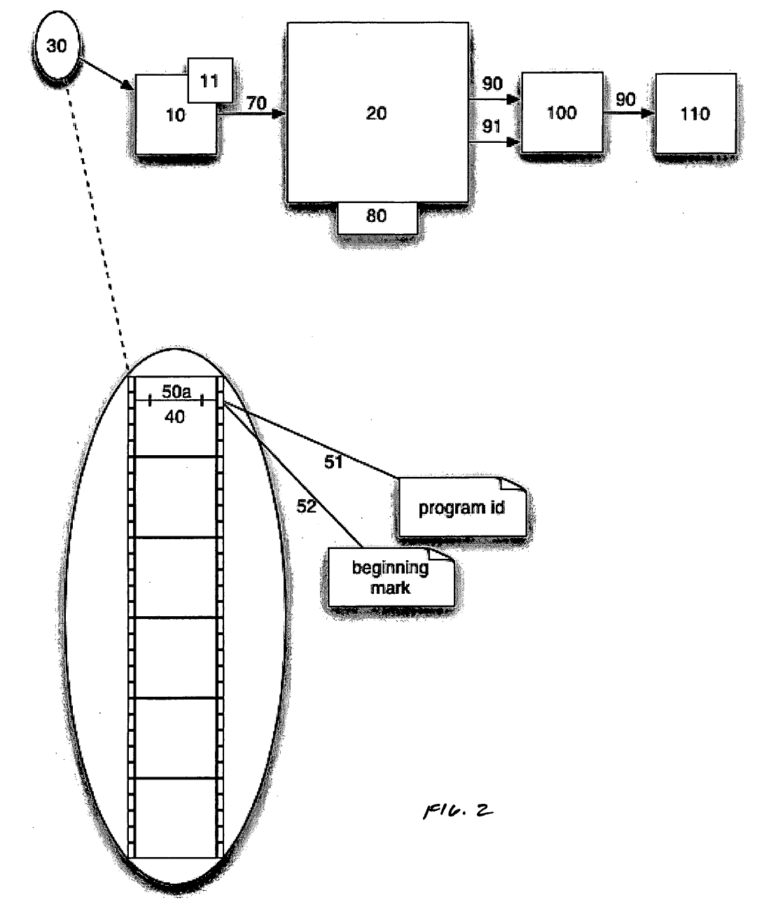

FIG. 2 shows a flow chart with further details of the flow chart shown in FIG. 1. The media program 30 may be displayed using the terminal 10 including at least one verifiable segment 40 marked with a verification marking 50a. In this embodiment, the verification marking 50a includes a program identification mark 51 and a beginning mark 52. The program identification mark 51 and the beginning mark 52 may contain the same information as the verifiable segment 40, or the program identification mark 51 may be a unique identifier and the beginning mark 52 may be the timestamp identifier of the beginning of a particular verifiable segment within the media program 30. When the observation application 11 on terminal 10 detects that the point in the program identified by the verification marking 50a has been displayed, the detection message 70 is sent to the server 20. The detection message 70 includes the program identification mark 51 and the information that the point in the program identified by the beginning mark 52 has been displayed. The server 20 subjects the detection message 70 to a segment display verification 80. In this embodiment, the segment display verification 80 includes receiving the detection message 70. When the server 20 receives the detection message 70, it verifies that segment 40 has been displayed and sends a verification message 90 to a database 100, and then may determine if a subscriber 110 has contracted to provide compensation if segment 40 is displayed and if so, forwards the information to the subscriber 110, which then provides the compensation. Otherwise, a non-verification 91 is sent to a database 100, indicating that a partial display has occurred.

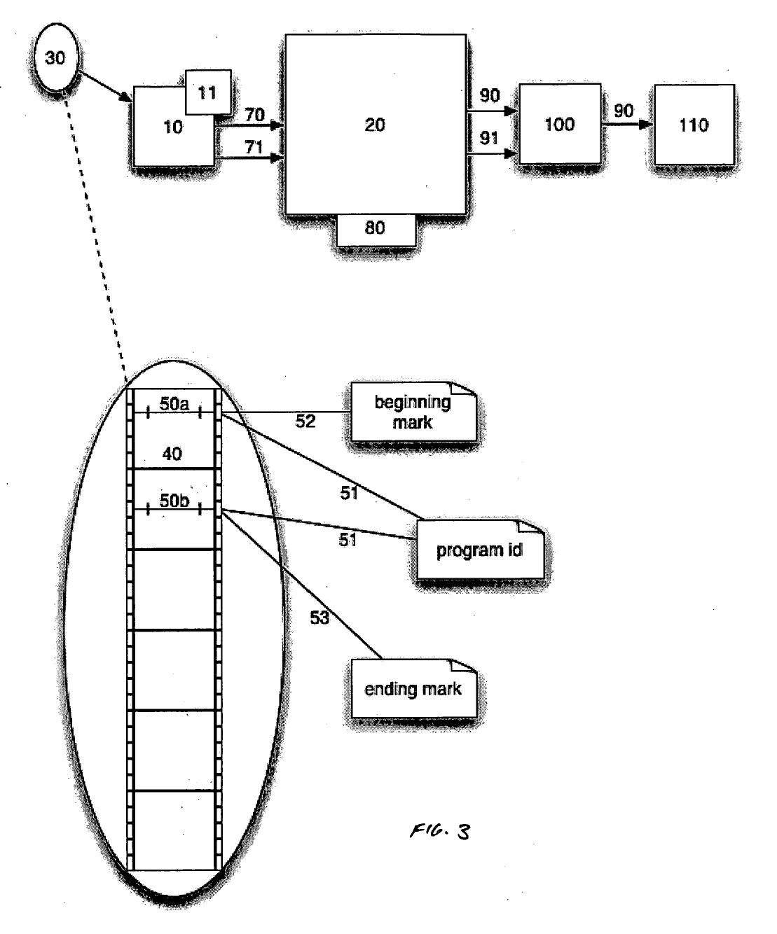

FIG. 3 illustrates a further embodiment of the invention. The media program 30 is displayed using one or more terminals 10. The media program 30 contains at least one verifiable segment 40 marked with the verification marking 50a and the ending marking 50b. In this embodiment, the verification marking 50a includes a program identification mark 51 and the beginning mark 52, and the ending marking 50b includes a program identification mark 51 and an ending mark 53. The beginning mark 52 may be the timestamp identifier of the beginning of verifiable segment 40. The ending mark 53 may be the timestamp identifier of the ending of the verifiable segment 40. When the observation application 11 on the terminal 10 detects that the point in the program identified by the verification marking 50a has been displayed, the detection message 70 is sent, including the program identification mark 51 and the information that the point in the program identified by the beginning mark 52 has been displayed, to the server 20.

The server 20 stores the detection message 70. When the observation application 11 on the terminal 10 detects that the point in the program identified by the ending marking 50b has been displayed, the detection message 71 is sent, including the program identification mark 51 and the information that the point in the program identified by the ending mark 53 has been displayed, to the server 20. When a display of verifiable segment 40, defined by the receipt of a detection message 70 followed by a message 71 with a matching program identification mark 51, is received by server 20, the server 20 subjects the verifiable segment 40 to a segment display verification 80. In this embodiment, the segment display verification 80 includes receipt of a detection message 70 followed by receipt of a message 71 with a matching program identification mark 51. If this condition is met, the display of the verifiable segment 40 is granted a verification message 90. The verification message 90 is then sent to a database 100 by the server 20, which then determines if a subscriber 110 has contracted to provide compensation if the segment 40 is displayed and forwards the information to the subscriber 110, which provides the agreed upon compensation. Otherwise, a non-verification message 91 is sent to the database 100, indicating that a partial display has occurred.

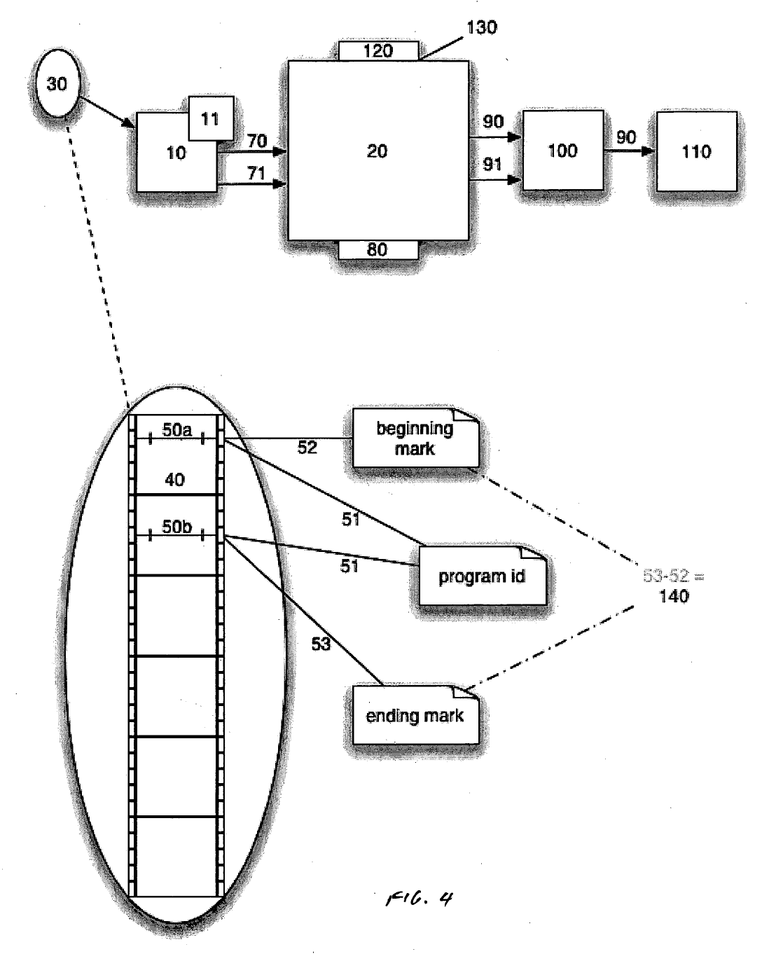

FIG. 4 illustrates a further embodiment of the invention. The media program 30 is displayed on the terminals 10. The media program 30 includes at least one verifiable segment 40 marked with the verification marking 50a and the ending marking 50b. In this embodiment, the verification marking 50a includes the program identification mark 51 and the beginning mark 52, and the ending marking 50b includes the program identification mark 51 and the ending mark 53. The beginning mark 52 may be the timestamp identifier of the beginning of the verifiable segment 40. The ending mark 53 may be the timestamp identifier of the ending of the verifiable segment 40. When the observation application 11 on the terminal 10 detects that the point in the program identified by the verification marking 50a has been displayed, the detection message 70 is sent, including the program identification mark 51 and the information that the point in the program identified by the beginning mark 52 has been displayed, to the server 20. The server 20 stores the detection message 70 and starts the timer 120, which records the time at which the message 70 was received. When the observation application 11 on the terminal 10 detects that the point in the program identified by the ending marking 50b has been displayed, the detection message 71 is sent, including the program identification mark 51 and the information that the point in the program identified by the ending mark 53 has been displayed, to the server 20. When the server 20 receives the detection message 71, the timer 120 stops and the elapsed time between receipt of the message 70 and receipt of the message 71 is calculated. The server 20 subjects the verifiable segment 40 to the segment display verification 80. In this embodiment, the segment display verification 80 compares the elapsed time 130 between the reception of the message 70 and the reception of the message 71 within tolerance of normal speed playing time 140. If elapsed time 130 is within tolerance of normal speed playing time 140, the display of the verifiable segment 40 is granted the verification message 90. The verification message 90 is sent by the server 20 to the database 100, which may then determine if a subscriber 110 has contracted to provide compensation if segment 40 is displayed and forwards the information to the subscriber 110, which provides the agreed upon compensation. Otherwise, the non-verification message 91 is sent to the database 100, indicating that a partial display has occurred.

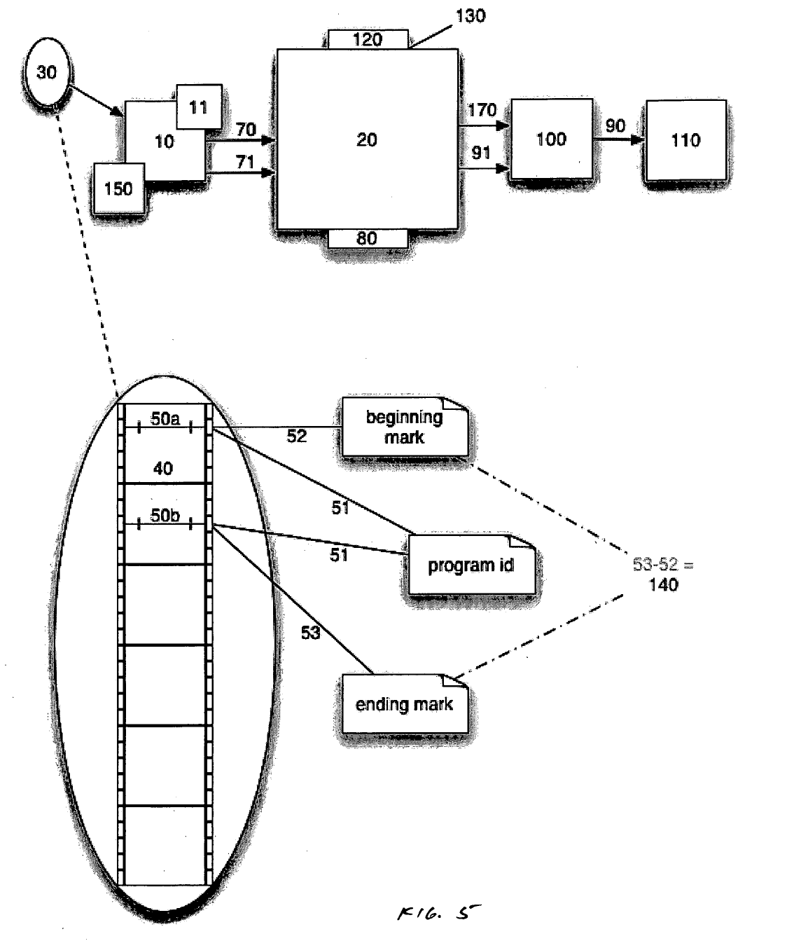

FIG. 5 illustrates a further embodiment of the invention. The media program 30 is displayed using the terminal 10. The media program 30 includes at least one verifiable segment 40 marked with the verification marking 50a and the ending marking 50b. In this embodiment, the verification marking 50a includes the program identification mark 51, the beginning mark 52, and an unique identification 150. The beginning mark 52 may be the timestamp identifier of the beginning of the verifiable segment 40. The unique identification 150 may be the cable card identifier, host identifier, serial number, or Internet address or a unique identification generated or obtained by the observation application 11, and associated with the terminal 10 where the media program 30 is played. In this embodiment the ending marking 50b includes the program identification mark 51, ending mark 53, and unique identification 150. The ending mark 53 may be the timestamp identifier of the ending of the verifiable segment 40. When the observation application 11 on the terminal 10 detects that the point in the program identified by the verification marking 50a has been displayed, the detection message 70 is sent, including the program identification mark 51, unique identification 150 and the information that the point in the program identified by the beginning mark 52 has been displayed, to the server 20. The server 20 stores the message 70 and starts the timer 120, which records the time at which the message 70 was received. When the observation application 11 on the terminal 10 detects that the point in the program identified by the ending marking 50b has been displayed, the message 71 is sent, including the program identification mark 51, the unique identification 150, and the information that the point in the program identified by the ending mark 53 has been displayed, to the server 20. When the server 20 receives the message 71, the timer 120 may stop and the elapsed time between receipt of the message 70 and receipt of the message 71 is calculated. The server 20 subjects the verifiable segment 40 to the segment display verification 80. In this embodiment, the segment display verification 80 includes comparing the elapsed time 130 between the reception of message 70 and the reception of the message 71 within tolerance of normal speed playing time 140. If elapsed time 130 is within the tolerance of normal speed playing time 140, the display of the verifiable segment 40 is granted the verification message 90. The verification message 90 is then combined with unique identification 150 to form a uniquely identified verification 170. The uniquely identified verification 170 is then sent to the database 100 by the server 20, which may then determine if a subscriber 110 has contracted to provide compensation if the segment 40 is displayed and forwards the information to the subscriber 110, which provides the agreed upon compensation. Otherwise, the verification message 91 is sent to the database 100, indicating that a partial display has occurred.

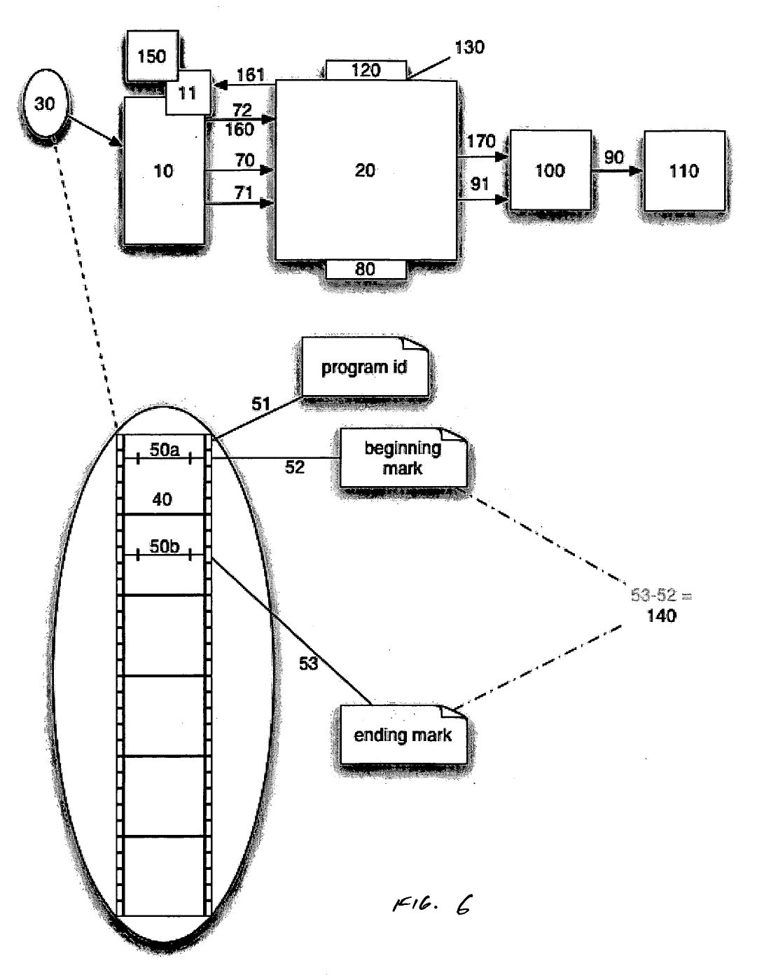

FIG. 6 illustrates a further embodiment of the invention. The media program 30 is displayed using the terminal 10. The media program 30 contains at least one verifiable segment 40 marked with the verification marking 50a and the ending marking 50b. In this embodiment, the verification marking 50a includes the beginning mark 52 and the unique identification 150. The beginning mark 52 may be the timestamp identifier of the beginning of verifiable segment 40. In this embodiment, the verification marking 50b includes ending mark 53 and unique identification 150. The ending mark 53 may be the timestamp identifier of the ending of the verifiable segment 40. When the media program 30 begins to display, the observation application 11 on terminal 10 sends a message 72 which may include the program identification mark 51 and the unique identification request 160 to the server 20. The server 20 creates the unique identification 150, associates it with program identification mark 51 and assigns unique identification 150 in the message 161 to the observation application 11, which stores the unique identification 150 in its memory. When the observation application 11 on terminal 10 detects that the point in the program identified by the verification marking 50a has been displayed, the message 70 is sent, including the unique identification 150, and the information that the point in the program identified by the beginning mark 52 has been displayed, to the server 20. The server 20 stores the message 70 and starts the timer 120, which records the time at which the message 70 was received. When the observation application 11 on the terminal 10 detects that the point in the program identified by the ending marking 50b has been displayed, the message 71 is sent, including the unique identification 150 and the information that the point in the program identified by the ending mark 53 has been displayed, to the server 20. When the server 20 receives the message 71, the timer 120 may stop and the elapsed time between receipt of the message 70 and receipt of the message 71 is calculated. The server 20 subjects the verifiable segment 40 to the segment display verification 80. In this embodiment, the segment display verification 80 includes comparing the elapsed time 130 between the reception of the message 70 and the reception of the message 71 within tolerance of normal speed playing time 140. If the elapsed time 130 is within tolerance of normal speed playing time 140, the display of the verifiable segment 40 is granted the verification 90. The Verification 90 is then combined with the unique identification 150 to form the uniquely identified verification 170. The uniquely identified verification 170 is then sent to the database 100 by the server 20, which may then determine if a subscriber 110 has contracted to provide compensation if the segment 40 is displayed and forwards the information to the subscriber 110, which provides the agreed upon compensation. Otherwise, the verification 91 is sent to the database 100, indicating that a partial display has occurred.

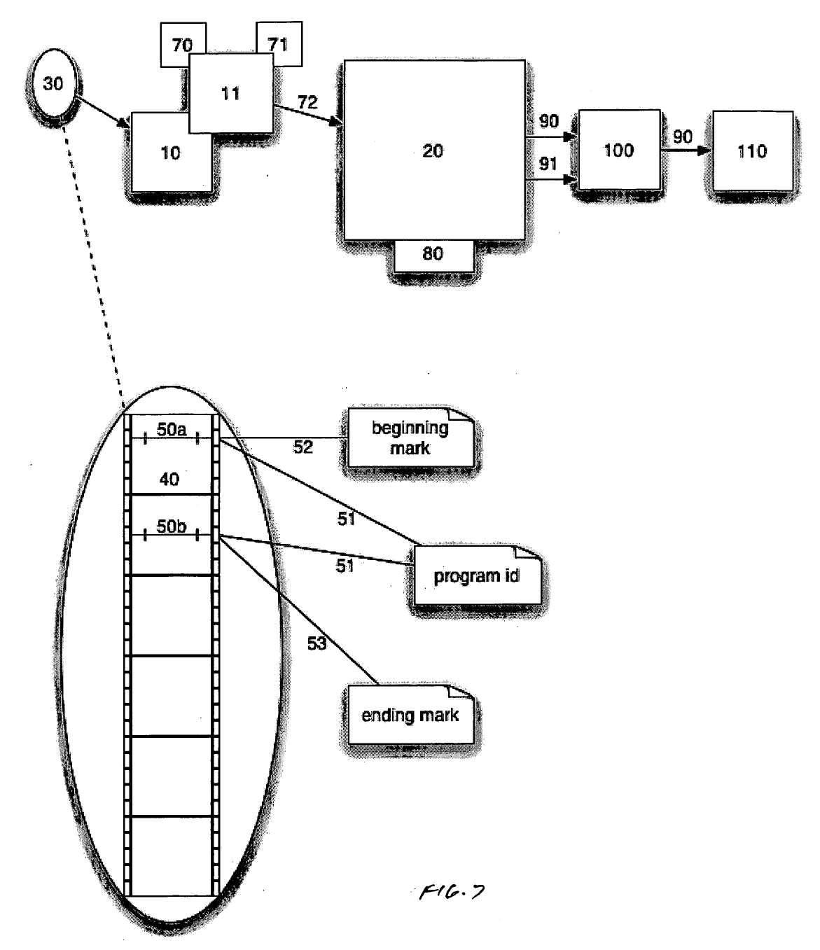

FIG. 7 illustrates a further embodiment of the invention. The media program 30 is displayed using the terminal 10. The media program 30 contains at least one verifiable segment 40 marked with the verification marking 50a and the ending marking 50b. In this embodiment, the verification marking 50a includes program the identification mark 51 and the beginning mark 52, and the ending marking 50b includes the program identification mark 51 and the ending mark 53. The beginning mark 52 may be the timestamp identifier of the beginning of the verifiable segment 40. The ending mark 53 may be the timestamp identifier of the ending of the verifiable segment 40. When the observation application 11 detects that the media program is being played on the terminal 10, it may determine that it cannot contact the server 20. Such a situation may occur if the network connection from terminal 10 is inactive. The observation application 11 on the terminal 10 then detects that the point in the media program 30 identified by the verification marking 50a has been displayed, it stores the message 70, including the program identification mark 51 and the information that the point in the program identified by the beginning mark 52 has been displayed, along with the current time of day. The observation application 11 may store the message 70 in its memory or to a file. When the observation application 11 on the terminal 10 detects that the point in the program 30 identified by the ending marking 50b has been displayed, it stores the message 71, including the program identification mark 51 and the information that the point in the program identified by the ending mark 53 has been displayed, along with the current time of day. The observation application 11 on the terminal 10 then waits for an active network connection to server 20. When the observation application 11 on the terminal 10 detects that an active network connection exists, the message 72 is sent to the server 20. The message 72 may include stored messages 70 and 71. The server 20 subjects the verifiable segment 40 to the segment display verification 80 by evaluating the messages 70 and 71 to determine if the difference in the time of day in the message 70 and the time of day in the message 71 is within tolerance of normal playing time of the beginning mark 52 and the ending mark 53. If this condition is met, the display of verifiable segment 40 is granted the verification 90. The verification 90 is then sent to the database 100 by the server 20, which may then determine if a subscriber 110 has contracted to provide compensation if the segment 40 is displayed and forwards the information to the subscriber 110, which provides the agreed upon compensation. Otherwise, the verification 91 is sent to the database 100, indicating that a partial display has occurred.

1. A method of verifying that a predefined segment of a media program has been detected at one or more terminals, the method including:
receiving a detection message from a terminal that a verification mark for a predefined segment within a media program has been detected at a terminal; and
requesting a compensation from a subscriber for detecting the verification mark of the predefined segment on the terminal.

2. The method according to claim 1, further including storing the detection message for later retrieval.

3. The method according to claim 1, further including:
receiving a subsequent detection message from the terminal that a subsequent verification mark for the predefined segment within the media program has been detected at the terminal; and
verifying that the predefined segment has been played if the time between the verification marks of the predefined segment of the media program is within a predetermined range of time.

4. The method according to claim 1, where the detection message includes a terminal identification number.

5. The method according to claim 1, including storing the detection message within the terminal until verifying that the verification mark for the predefined segment has been detected at the terminal.

6. A verification system capable of verifying to a subscriber that its predefined segment within an media program has been detected at one or more terminals and requesting a compensation from the subscriber, the system comprising:
a server adapted to receive a detection message from a plurality of terminals, the detection message including a verification mark of a predefined segment and that the verification mark has been detected on the terminal that sent the detection message; and
a database communicably coupled to the server, the server sending a verification statement to the database if the predefined segment has been detected, based on the verification statement requests a compensation from the subscriber for verifying the detection message on the terminal.

7. The verification system according to claim 1, including a distributor having a plurality of media programs with at least one predefined segment, where a predetermined subscriber has agreed to provide compensation if the at least one predefined segment is detected at one or more of the plurality of terminals.

8. The verification system according to claim 1, where the detection message includes a segment identification number corresponding to the predefined segment.

9. The verification system according to claim 1, where the verification mark is a timestamp identifier associated with the predefined segment within the media program.

10. The verification system according to claim 1, where the detection message includes a terminal identification to indicate which of the plurality of terminals has detected the verification mark.

11. The verification system according to claim 1, where the server assigns a unique identification associated with each the plurality of terminals.

12. The verification system according to claim 1, where each of the plurality of terminals has an observation application that is capable of creating or obtaining a unique identification associated with its terminal.

13. The verification system according to claim 1, where the server is adapted receive a subsequent detection message from the terminal that sent the earlier detection message, the subsequent detection message including subsequent verification mark of the predefined segment and that the subsequent verification mark has been detected at the terminal such that the sever can verify that the verification marks have been detected at the terminal.

14. The verification system according to claim 13, where the server includes a timer, the server verifying that the segment has been detected if the time between the verification marks of the predefined segment in the media program is detected within a predetermined range of time.

15. A verification system capable of verifying to a subscriber that its predefined segment within an media program has been displayed at one or more terminals and requesting a compensation from the subscriber, the system comprising:
means for verifying that a predefined segment within a media program has been detected at a terminal; and
means for requesting a compensation from a subscriber for verifying that the predefined segment within the media program was detected on the terminal.

16. The verification system according to claim 15, where the means for verifying is a server adapted to receive a detection message from a plurality of terminals, the detection message including a verification mark of a predefined segment and that the verification mark has been detected on the terminal that sent the detection message.

17. The verification system according to claim 16, a database is communicably coupled to the server, the server sending a verification statement to the database if the predefined segment has been detected, the database or server based on the verification statement requests a compensation from the subscriber for verifying the detection message on the terminal.

18. The verification system according to claim 16, where the server assigns a unique identification associated with each the plurality of terminals.

19. The verification system according to claim 16, where each of the plurality of terminals has an observation application that is capable of creating or obtaining a unique identification associated with its terminal.

20. The verification system according to claim 16, where the server is adapted receive a subsequent detection message from the terminal that sent the earlier detection message, the subsequent detection message including subsequent verification mark of the predefined segment and that the subsequent verification mark has been detected at the terminal such that the sever can verify that the verification marks have been detected at the terminal.
